(19) United States
(12) Patent Application Publication
(10) Pub. No.: US 2016/0338147 A1
(43) Pub. Date: Nov. 17, 2016

(54) ELECTRICAL RESISTANCE HEATER ASSEMBLY

(71) Applicant: Eichenauer Heizelemente GmbH & Co. KG, Kandel (DE)

(72) Inventor: Andreas Mueller, Rheinzabern (DE)

(21) Appl. No.: 14/714,135

(22) Filed: May 15, 2015

(51) Int. Cl. H05B 3/00; H05B 3/46; H05B 3/06

(52) U.S. Cl. CPC H05B 3/0014; H05B 3/06; H05B 3/46

(57) ABSTRACT

An electrical resistance heater assembly includes a tubular housing, a first mica board supporting a first heater ribbon running in a looped configuration along rows that are substantially perpendicular to a longitudinal direction of the heater assembly, said rows being defined by series of mounting holes through which loops of the heater ribbon protrude. This mica board can be stacked on top of a second mica board supporting a second heater ribbon in looped configuration. The mica board or boards can be provided with empty openings that are arranged between adjacent rows in order to prevent buckling of the mica boards at elevated temperatures.

### CROSS-REFERENCE TO RELATED APPLICATIONS

None

### DESCRIPTION

1. Field of the Invention

The present invention relates to an electrical resistance heater assembly for heating air. Such electrical resistance heater assemblies are used in clothes dryers.

2. Background of the Invention

An electrical resistance heater assembly disclosed in US 2012/0180334 A1 comprises a mica board supporting a first heater ribbon running in a looped configuration along rows that are substantially perpendicular to a longitudinal direction of the mica board, said rows being defined by series of mounting holes through which loops of the heater ribbon protrude. Adjacent rows are each connected by a single trapezoidal hole configured to turn the heater ribbon by 180°.

A problem of known electrical heater assemblies is that in use elevated temperatures can be reached causing mica boards to buckle. This problem can be avoided by using ceramic boards that can withstand higher temperatures. However, such ceramic boards are much more expensive.

An object of the present invention is to provide an electrical heater assembly comprising one or more mica boards that enables increased operating temperatures.

### SUMMARY OF THE INVENTION

This object can be achieved by providing the mica board or boards with empty openings that are arranged between the rows of heater ribbon loops and are preferably larger than the mounting holes defining the rows. The mounting holes have opposing edges that are each touched by a section of the loop held in the respective mounting hole. Mica boards of prior art heater assemblies have numerous holes or openings that serve different purposes, e.g. rivet holes for rivets or mounting holes for holding heater ribbons. Such holes of prior art heater assemblies are not empty as they contain rivets, heater ribbons or other parts. The empty openings of the present invention serve to increase the elasticity of mica boards so that thermal expansions of the mica board are less likely to cause buckling. The empty openings thus increase the temperature tolerance of the heater assembly. In order to have a significant effect, the total area of all empty opening should be above 5% of the area of the mica board.

This object can also be achieved by connecting adjacent rows between terminal ends of the heater ribbon by arranging a plurality of substantially trapezoidal holes on a semicircle. Instead of turning the heater ribbon with a single trapezoidal hole between adjacent rows by 180°, this turning is achieved in a plurality of smaller steps. Thereby the mechanical load caused by bending and turning of the heater ribbon is reduced. Thus the risk of breaking is lower and heater ribbon of an increased width can be used. The larger the width of the heater ribbon the larger is the heating power that can be used. Thus larger operating temperatures can be achieved. The holes need not have a precisely trapezoidal shape because the bases of the trapezoid are not relevant, only the edges connecting the bases matter as they touch the heater ribbon. The bases of the trapezoid may therefore also be curved. Such a shape is considered to be substantially trapezoidal within the context of the application. The edges connecting the bases are arranged at an acute angle with respect to each other.

This object can also be achieved by providing the mica board at the terminal ends of the heater ribbon with an elongated hole which holds in addition to a loop of heater ribbon a section of heater ribbon that can be connected to a connecting part fixed to the first mica board. Thermal expansion of the heater ribbon causes severe stress, especially between the connecting part and the loop adjacent to it. An elongated hole fixes the loop adjacent to the connecting part only on the side facing away from the connecting part. Hence, the heater ribbon can move and thereby release mechanical stress much better. Thus the heater ribbon can stand higher temperatures and many heating-cooling cycles without breaking.

### BRIEF DESCRIPTION OF THE DRAWINGS

The above-mentioned aspects of the invention will become more apparent and will be better understood by reference to the following description of embodiments taken in conjunction with the accompanying drawings, wherein:

FIG. 1 shows an embodiment of an electrical resistance heater assembly;

FIG. 2 shows the embodiment of FIG. 1 without the housing;

FIG. 3 shows a mica board of the embodiment of FIG. 1;

FIG. 4 shows schematically a first possibility of connecting heater ribbon in an assembly according to FIG. 1;

FIG. 5 shows schematically a second possibility of connecting heater ribbon in an assembly according to FIG. 1;

FIG. 6 shows schematically a third possibility of connecting heater ribbon in an assembly according to FIG. 1;

FIG. 7 shows schematically a fourth possibility of connecting heater ribbon in an assembly according to FIG. 1;

FIG. 8 shows schematically a fifth possibility of connecting heater ribbon in an assembly according to FIG. 1; and

FIG. 9 shows a detail of the embodiment of FIG. 1.

### DETAILED DESCRIPTION OF THE PREFERRED EMBODIMENTS

Corresponding reference characters indicate corresponding or similar parts throughout all figures.

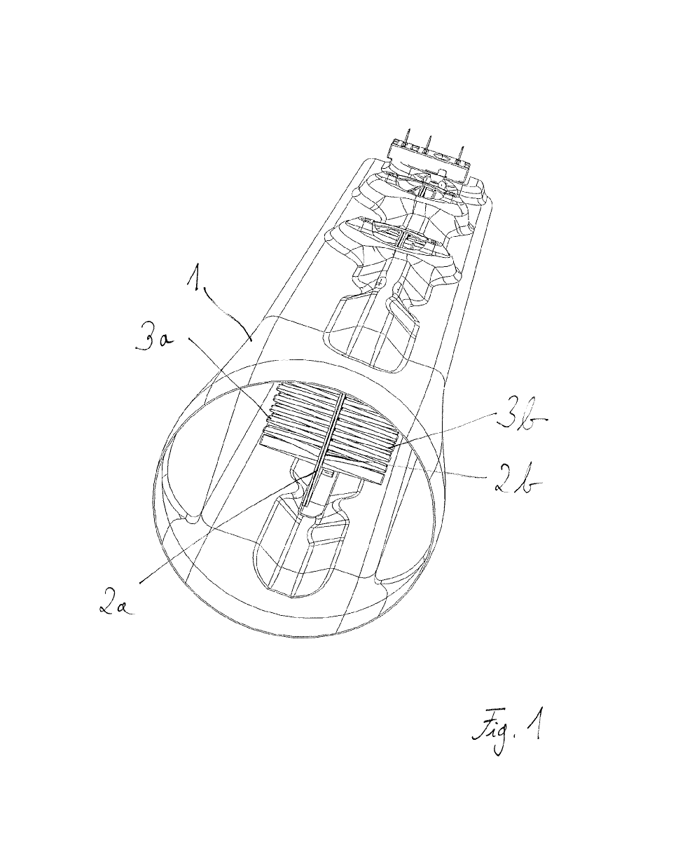

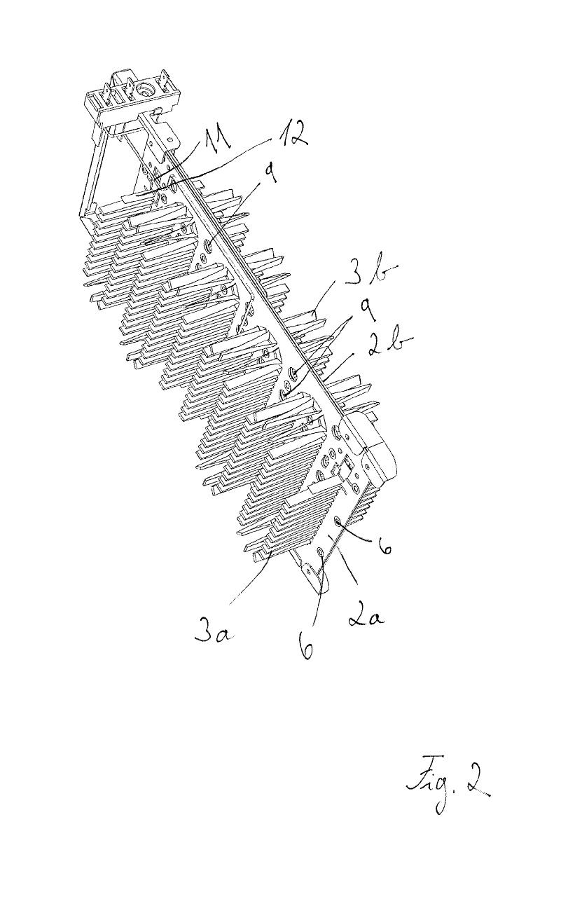

FIG. 1 shows an electrical resistance heater assembly comprising a tubular housing 1 and two or more elongated mica boards 2a, 2b supporting heater ribbon 3a, 3b. FIG. 2 shows the electrical resistance heater assembly without the tubular housing. The first and the second mica board 2a, 2b each support heater ribbon 3a, 3b running in a looped configuration along rows that are substantially perpendicular to a longitudinal direction of the heater assembly. Thus the rows are also perpendicular to a longitudinal direction of the mica board 2a, 2b and perpendicular to a longitudinal direction of the tube housing. These rows are defined by mounting holes through which the loops of the heater ribbon 3a, 3b protrude.

As can been seen, the heater ribbon 3a, 3b is bent into loops which form zigs and zags of a zigzag shape and protrude through mounting holes 4. The zigzag shape has lower apexes, which are connected to the respective mica board, and upper apexes, which are distanced from the respective mica board. By arranging the lower apexes at the mica boards, e.g. by clamping, sagging of the heater ribbon and, even in case of its breaking, shorts are prevented.

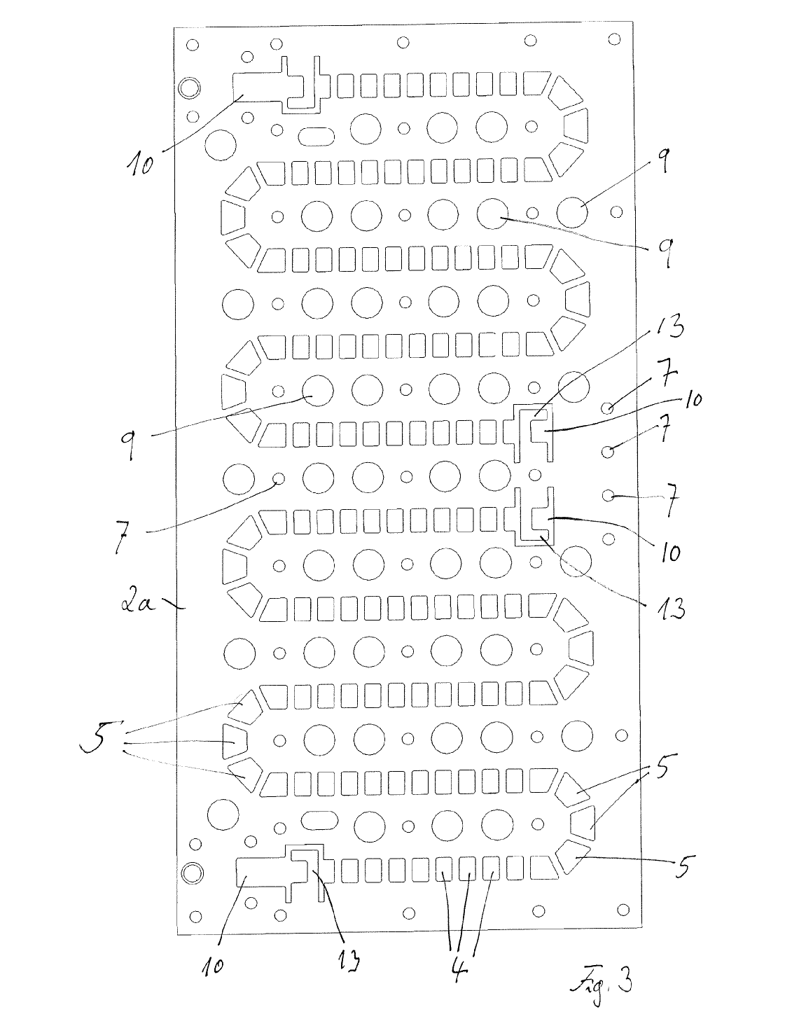

The mica boards 2a, 2b can be identical in shape or slightly different. An embodiment of the first mica board 2a is shown in FIG. 3. The mica board 2a has rows of mounting holes 4 for the loops of the heater ribbon 3a. These mounting holes can have a substantially rectangular shape such that opposing sections of a loop touch opposite sides of the mounting hole 4.

The rows of mounting holes 4 are connected by substantially symmetrical, trapezoidal holes 5 configured to each hold a loop of the heater ribbon 3a. These connecting holes 5 cause a U-turn between adjacent rows and are arranged between adjacent rows. The last hole of each row may have an asymmetrical shape, but is not counted as a connecting hole. Thus the heater ribbon 3a is turned by 180° for travel from one row to an adjacent row. Each connecting hole 5 causes a part of that U-turn. In the embodiment shown there are three connecting holes 5 between adjacent rows, although there may be more or less connecting holes 5. The lateral edges of the connecting holes 5 may, for example, enclose an angle of 45° or less. The first connecting hole has an edge that is parallel to the neighboring edge of the mounting hole 4 and an edge that is parallel to the neighboring edge of second connecting hole 5. Also each loop held in one of the substantially symmetrical connecting holes differs by an acute angle from the orientation of a loop held in an adjacent hole.

The mounting holes 4 have a length measured in a longitudinal direction of the rows and a width measured in a direction perpendicular to the longitudinal direction of the rows. The length of the mounting holes 4 is smaller than their width. The width of the heater ribbon 3a, 3b corresponds to the width of the mounting holes 4. Thus the heater ribbon 3a, 3b can have a significantly larger width than heater ribbon in conventional electrical resistance heater assemblies. The heater ribbon 3a, 3b used in the embodiment shown can have a width that is 30 times as large as its thickness. The width can be even larger relative to the thickness of the heater ribbon, e.g. 40 times as large as the thickness or more. A larger width of the heater ribbon 3a, 3b allows transferring a correspondingly larger amount of heat to an air flow. A large width of the heater ribbon 3a, 3b increases stiffness and makes turning the heater ribbon from one row of loops to the next row more problematic. This problem can be solved by increasing the number of trapezoidal holes 5 between adjacent rows.

As FIGS. 1 and 2 show, the first mica board 2a with the first heater ribbon 3a and the second mica board 2b with the second heater ribbon 3b are stacked on top of each other. Thereby a more uniform air flow and cooling of the heater ribbons 3a, 3b can be achieved. The mica boards can be held together by rivets 6 or clamps, for example. Rivet holes 7 for holding rivets 6 are shown in FIG. 3.

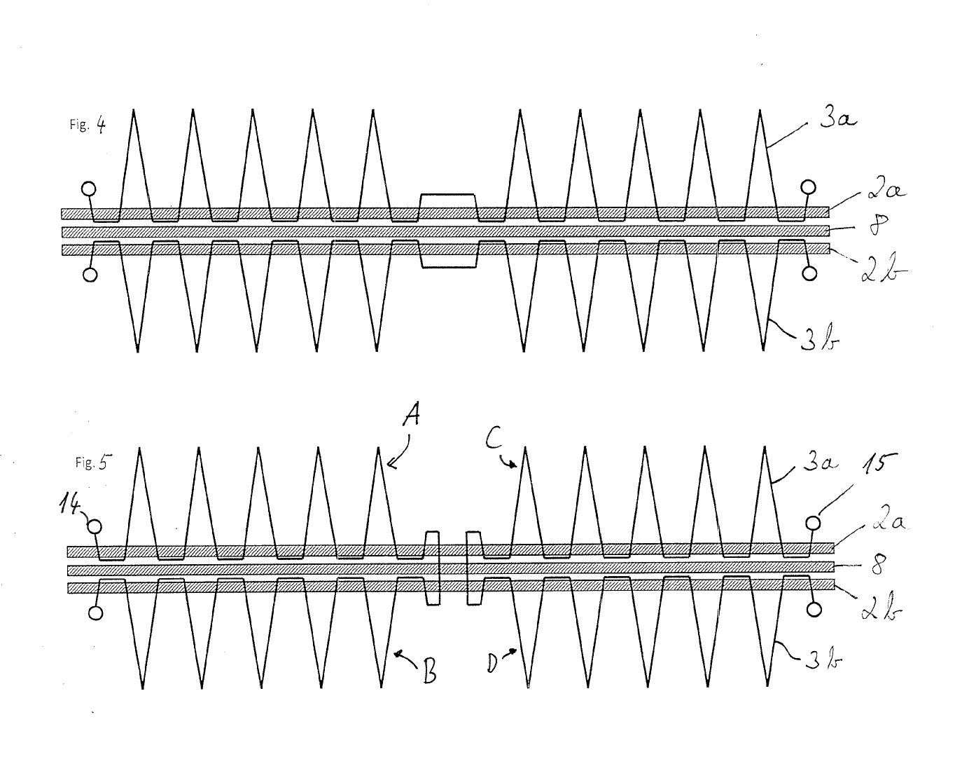

FIGS. 4 to 8 show schematically various possibilities of how mica boards can be stacked and the heater ribbons electrically connected. For purposes of simplification, these figures show the loops of the heater to be arranged in a longitudinal row from one end of the stack of mica boards to the opposite end. Of course, the loops are really oriented as shown in FIG. 2.

One possibility illustrated in FIGS. 4, 5, and 8 is to place a third mica board 8 between the first mica board 2a and the second mica board 2b. The third mica board 8 can electrically insulate the first heater ribbon 3a of the first mica board 2a from the heater ribbon 3b of second mica board 2b. FIG. 4 shows an embodiment wherein the first heater ribbon 3a of the first mica board 2a can be heated by electrical current independently of the second heater ribbon 3b of the second mica board 2b. Thus by connecting either both heater ribbons 3a, 3b or only one of them to a power supply, the full heating power of the electrical resistance heater assembly or only a part of it, e.g. half of it, can be applied. This is referred to as a first power setting (if voltage is applied to only one of the heater ribbons) and a second power setting (if voltage is applied to two heater ribbons). Additional power settings can be provided by adding more heater ribbons.

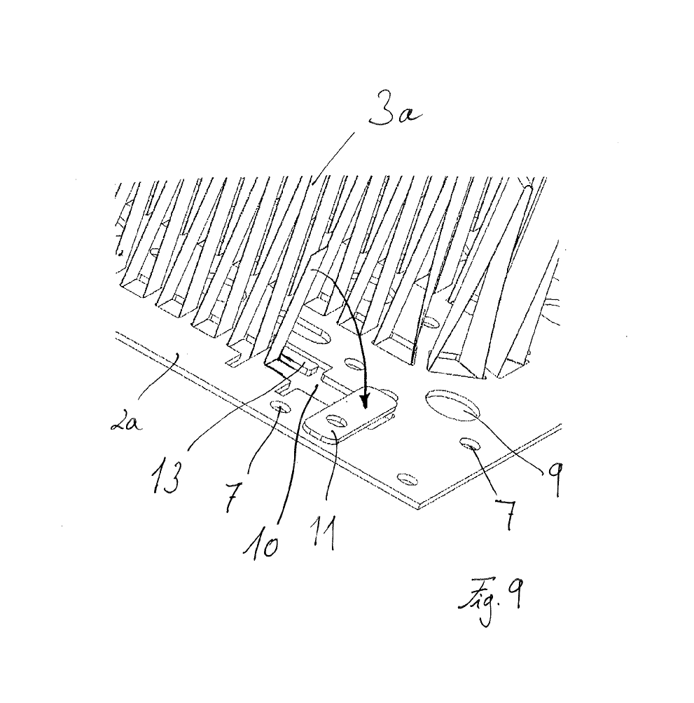

Similar results can be achieved by electrically connecting the first heater ribbon 3a of the first mica board 2a and the second heater ribbon 3b of the second mica board 2b in series and to add another heater ribbon that likewise forms loops on the first mica board 2a and on the second mica board 2b as shown in the embodiments of FIGS. 5 and 8. If only part of the full heating power is used and voltage applied only to one of two or only to some of a larger number of heater ribbons, the embodiment of FIG. 5 offers the advantage that the first mica board 2a and the second mica board 2b are equally heated and thus subjected to them same thermal stress. Then both mica boards show the same or nearly the same thermal expansion and are stable in their flat configuration. If one mica board is heated to a higher temperature than the other, it will be subject to a larger thermal expansion causing a bending force to act on the stack of mica boards. The number of loops supported by the first mica board can be the same as the number of loops supported by the second mica board to heat all board equally.

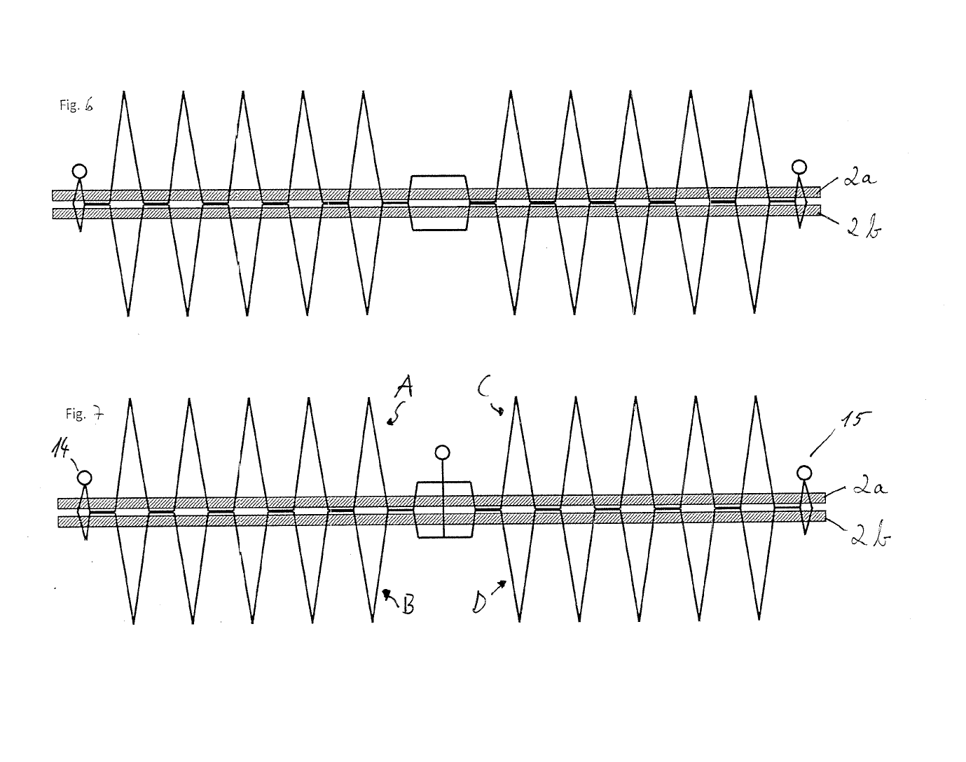

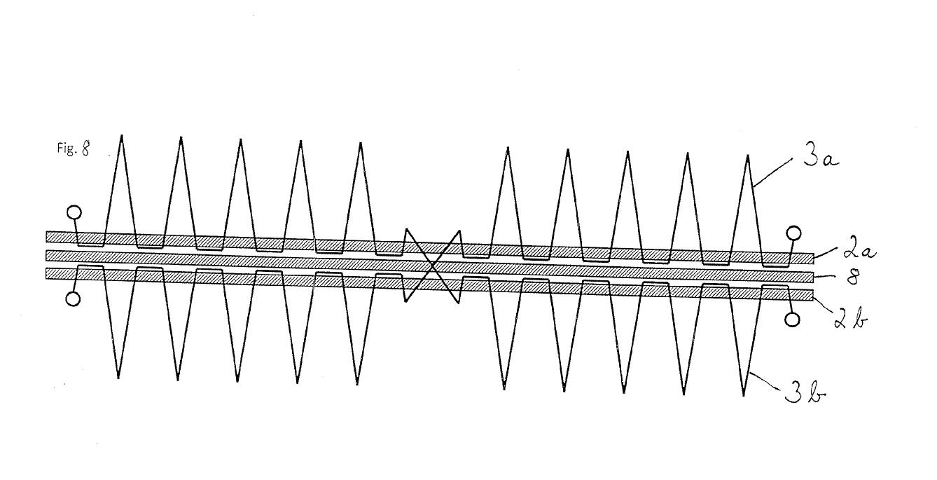

If there is no third mica board between the first mica board 2a and the second mica board 2b, as shown in the embodiments of FIGS. 6 and 7, the loops of the first heater ribbon 3a supported by the first mica board 2a and the loops of the second heater ribbon 3b supported by the second mica board 2b can contact each other. Then the first and the second heater ribbon 3a, 3b are connected in parallel. In the embodiment of FIG. 6 voltage is either applied all heater ribbons or to none. Thus there is only one power setting. In the embodiment of FIG. 7 sections of the electrical resistance heater assembly can be supplied with power independently via an additional terminal. Thus there are two power settings. Each power setting has the number of loops supported by the first mica board 2a and the second mica board 2b.

In the embodiments of FIGS. 5 and 7 each power setting causes both the first and the second mica board 2a, 2b to be heated as in all power setting loops of heater ribbon on the first mica board 2a and loops on the second mica board are heated. A first series A of loops of heater ribbon that are supported by the first mica board 2a and a second series of loops B of heater ribbon that are supported by the second mica board 2b are electrically connected in series or in parallel. A first terminal 14 is provided for connecting the first and the second series of loops to a voltage source. Current will then flow through the first series A of loops of the first mica board 2a and also through the second series B of loops of the second mica board 2b.

For a second power setting, a third series C of loops of heater ribbon that are supported by the first mica board 2a and a fourth series of loops D of heater ribbon that are supported by the second mica board 2b are electrically connected in series or in parallel. A second terminal 15 is provided for connecting the third and the fourth series of loops to a voltage source. If current flows through the third series C of loops of the first mica board 2a, it flows also through the fourth series D of loops of the second mica board 2b.

In order to increase the resistance of the mica boards 2a, 2b, 8 against buckling at elevated temperatures the mica boards 2a, 2b, 8 are provided with empty openings 9 that are larger than the mounting holes 4 and also larger than any rivet holes 7. The openings 9 are arranged between the rows of mounting holes 4 and can have a circular shape as shown in FIG. 3. There is a plurality of these openings 9 between adjacent rows of mounting holes 4, e.g. three or more openings 9 between adjacent rows of mounting holes 4. The width of the openings 9 can be one quarter of the distance between adjacent rows of mounting holes 4 or more, e.g. one third of the distance between adjacent rows of mounting holes 4 or more.

As can be seen in FIG. 2, the openings 9 are empty, i.e. nothing protrudes through the openings 9. The openings 9 of the various mica boards 2a, 2b, 8 can be aligned with each other so that these openings 9 go through the whole stack of mica boards 2a, 2b, 8, but this is not necessary.

The mica board 2a shown in FIG. 3 is configured to support loops of two separate heater ribbons. Each series of rows of mounting holes 4 starts at a terminal hole 10 provided at an end of the longitudinal mica board and ends at a terminal hole 10 provided in an intermediate section of the mica board. Thus each pair of terminal holes 10 is connected by a series of rows of mounting holes 4, wherein adjacent rows of each series are connected by trapezoidal holes 5.

The terminal section of a heater ribbon 3a, 3b is subjected to severe mechanical stress caused by repeated thermal expansion and contraction of the heater ribbon 3a, 3b. This mechanical stress can be reduced by arranging a terminal loop, i.e. a first or last loop of the heater ribbon 3a, 3b in an elongated terminal hole 10 such that the terminal loop touches only one edge of the terminal hole 10. The other side of the terminal loop extends into a substantially horizontal section of the heater ribbon 3a, 3b. This substantially horizontal section of the heater ribbon can be connected to a connecting part 11, e.g. by welding. In FIG. 2 the final section 12 is shown vertically. To finish the manufacturing process the final section 12 is pivoted by about 90° so that it contacts the contacting part 11 as illustrated in FIG. 9. The final section 12 is then welded to the connecting part 11. Then a hook shaped section 13, best seen in FIGS. 3 and 9, may be removed from the mica board, e.g. by breaking off. By removing the hook shaped section 13 the elongated terminal hole 10 is completed. The terminal hole 10 then has two end sections that each has the same width as the mounting holes 4 and a wider intermediate section. The length of the terminal hole 10, measured in the direction of the row, is then more than twice as large as the length of one of the mounting holes 4.

The hook shaped section 13 need not be removed and may also be present in the finished heater. The hooked shaped section 13 is mechanically less strong than the heater ribbon. Thermal expansion of the heater ribbon causes the heater ribbon to exert a force on the hook shaped section. The hook shaped section 13 may then accommodate this force or, if the force is too high, break off. As the hook shaped section 13 is no longer needed in operation of the heater, breaking off of the hook shaped section is no problem.

### LIST OF REFERENCE SIGNS

1 tubular housing
2a, 2b mica board
3a, 3b heater ribbon
4 mounting hole
5 connecting hole
6 rivets
7 rivet hole
8 mica board
9 opening
10 terminal hole
11 connecting part
12 final section
13 hook shaped section of mica board
14 first terminal
15 second terminal
A first series of loops
B second series of loops
C third series of loops
D fourth series of loops

What is claimed is:

1. An electrical resistance heater assembly, comprising:
a first mica board supporting a first heater ribbon, the first heater ribbon running in a looped configuration along rows that are defined by a series of mounting holes in the first mica board through which loops of the heater ribbon protrude;
wherein the rows are substantially perpendicular to a longitudinal direction of the heater assembly; and
wherein between adjacent rows are openings in the first mica board that are empty, said empty openings have a total area of at least 5% of the area of the first mica board.

2. The electrical resistance heater assembly according to claim 1, wherein the empty openings are circular.

3. The electrical resistance heater assembly according to claim 1, wherein the empty openings have a width that is at least a quarter of the distance between adjacent rows.

4. The electrical resistance heater assembly according to claim 1, wherein between adjacent rows of the heater ribbon are each at least three of the empty openings in the first mica board.

5. The electrical resistance heater assembly according to claim 1, wherein the empty openings are larger than the mounting holes.

6. An electrical resistance heater assembly, comprising:
a first mica board that supports a first heater ribbon running in a looped configuration along rows that are substantially perpendicular to a longitudinal direction of the heater assembly:
said rows being defined by series of mounting holes in the first mica board through which loops of the first heater ribbon protrude; and
wherein a row of mounting holes is connected to an adjacent row of mounting holes by at least two connecting holes between adjacent rows, wherein the lateral edges of the connecting holes enclose an acute angle.

7. The electrical resistance heater assembly according to claim 6, wherein adjacent rows between terminal ends of the heater ribbon are connected by at least three connecting holes.

8. The electrical resistance heater assembly according to claim 6, wherein the connecting holes are arranged on a semi-circle.

9. The electrical resistance heater assembly according to claim 6, wherein the lateral edges of each connecting hole enclose an angle of 50° or less.

10. An electrical resistance heater assembly, comprising:
a first mica board that supports a first heater ribbon running in a looped configuration along rows that are substantially perpendicular to a longitudinal direction of the heater assembly;
said rows being defined by series of mounting holes in the first mica board through which loops of the first heater ribbon protrude; and
wherein at a terminal end of the first heater ribbon the series of mounting holes starts at a terminal hole in the first mica board, where the terminal hole is an elongated hole, and where the elongated hole holds a loop and a section of heater ribbon connecting the loop to a connecting part fixed to the first mica board.

11. The electrical resistance heater assembly according to claim 10, wherein the elongated hole comprises an end section that has the same width as the mounting holes and an intermediate section that has a larger width.

12. The electrical resistance heater assembly according to claim 1, further comprising a second mica board supporting a second heater ribbon running in a second looped configuration along second rows that are substantially perpendicular to the longitudinal direction of the heater assembly, said second rows being defined by a second series of mounting holes in the second mica board, through which the second series of mounting holes the loops of the second heater ribbon protrude, wherein a second set of empty openings are arranged in the second mica board between the second series of mounting holes, said second set of empty holes having a total area that is at least 5% of the area of the second mica board, and wherein the second mica board and the first mica board are arranged in a stacked configuration.

13. The electrical resistance heater assembly according to claim 12, wherein the loops of the first heater ribbon have lower apexes, which are arranged at an underside of the first mica board, and upper apexes, which are distanced from the first mica board, and wherein the loops of the second heater ribbon have lower apexes, which are arranged at an underside of the second mica board, and upper apexes, which are distanced from the second mica board, and where the lower apexes of the first and the second heater ribbon are arranged between the first and the second mica board.

14. The electrical resistance heater assembly according to claim 12, wherein a third mica board is arranged between the first mica board and the second mica board, the third mica board electrically insulating the loops of first heater ribbon from the loops of second heater ribbon, said third mica board having a third set of empty openings that have a total area that is at least 5% of the area of the third mica board.

15. The electrical resistance heater assembly according to claim 12, wherein the mica boards are riveted together by rivets arranged in rivet holes of the mica boards, said rivet holes being smaller than the empty openings.

16. The electrical resistance heater assembly according to claim 1, wherein the mounting holes have a length measured in a longitudinal direction of the rows and a width measured in a direction perpendicular to the longitudinal direction of the rows, the length of the mounting holes being smaller than their width.

17. The electrical resistance heater assembly according to claim 1, wherein the first heater ribbon has a width that is at least 30 times as large as its thickness.

18. An electrical resistance heater assembly, comprising:
a stack of a first mica board and a second mica board;
a first series of loops of heater ribbon running along rows that are substantially perpendicular to a longitudinal direction of the heater assembly, said rows being defined by a first series of mounting holes in the first mica board;
a second series of loops of heater ribbon running along rows that are substantially perpendicular to the longitudinal direction of the heater assembly, said rows being defined by second series of mounting holes in the second mica board;
said first series of loops and the second series of loops being electrically connected in series or in parallel;
a first terminal for connecting the first and the second series of loops to a voltage source;
a third series of loops of heater ribbon running along rows that are substantially perpendicular to the longitudinal direction of the heater assembly housing, said rows being defined by a third series of mounting holes in the first mica board;
a fourth series of loops of heater ribbon running along rows that are substantially perpendicular to the longitudinal direction of the heater assembly, said rows being defined by a fourth series of mounting holes in the second mica board;
said third series of loops and fourth series of loops being electrically connected in series or in parallel; and
a second terminal for connecting the third and the fourth series of loops to the voltage source.

19. The electrical resistance heater assembly according to claim 18, wherein the first series of loops and the second series of loops contain the same number of loops.

20. The electrical resistance heater assembly according to claim 18, wherein in a first power setting either the first and the second series or the third and the fourth series of loops are connect to the voltage supply, and wherein in a second power setting the first and the second series of loops are connected in parallel to the third and the fourth series of loops to the voltage supply.
